(19) United States
(12) Patent Application Publication
(10) Pub. No.: US 2009/0045054 A1
(43) Pub. Date: Feb. 19, 2009

(54) APPARATUS AND METHOD FOR ELECTROMAGNETICALLY DETECTING MICROORGANISM

(75) Inventors: Junil SOHN, Yongin-si (KR); Jaechan PARK, Yongin-si (KR); JungJoo HWANG, Suwon-si (KR); Yunwoo NAM, Yongin-si (KR); Kyoung Ho KANG, Hwaseong-si (KR); Taewan KIM, Yongin-si (KR)

Correspondence Address: CANTOR COLBURN, LLP, 20 Church Street, 22nd Floor, Hartford, CT, 06103, US

(73) Assignee: Samsung Electronics Co., LTD, Suwon-si (KR)

(21) Appl. No.: 12/139,812

(22) Filed: Jun. 16, 2008

(30) Foreign Application Priority Data
Aug. 13, 2007 (KR) 10-2007-0081411
Feb. 12, 2008 (KR) 10-2008-0012644

(51) Int. Cl. G01N 27/26

(52) U.S. Cl. 204/403.01

(57) ABSTRACT

An apparatus and a method for electromagnetically detecting microorganisms. The apparatus includes a pair of first electrodes which are positioned to be opposite to each other on a measuring cell and are connected to a power supply to generate an electric field around a solution contained in the measuring cell, a magnetic field generating unit which generates a magnetic field around the solution contained in the measuring cell in a perpendicular direction to the electric field, second electrodes which are positioned perpendicularly to both the electric field and the magnetic field, and a voltage measurer which measures the voltage generated between the second electrodes as the microorganisms move in the measuring cell. The apparatus determines the presence, quantity and identity of microorganisms with negative surface charge with improved sensitivity using the Hall effect.

This application claims priority to Korean Patent Application No. 10-2007-0081411 filed on Aug. 13, 2007, and Korean Patent Application No. 10-2008-0012644 filed on Feb. 12, 2008, and all the benefits accruing therefrom under 35 U.S.C. §119, the contents of which are herein incorporated by reference.

### BACKGROUND OF THE INVENTION

1. Field of the Invention

The present invention relates to an apparatus and a method for electromagnetically detecting microorganisms, and more particularly, to an apparatus and a method capable of simply and rapidly detecting the presence and the amount of microorganisms in gas or liquid and analyzing the identity thereof in an electromagnetic manner.

2. Description of the Related Art

In recent years, a combination tendency of the biotechnology (“BT”) and the nanotechnology (“NT”) promotes a development of hybrid nanomaterial using a biomaterial property capable of being singularly combined.

The interdisciplinary combinations are creating new frontier technologies. In particular, the combination of information technology (“IT”), NT and BT has become an absolute necessity. From such combination, it has become possible to utilize the digital information quickly and accurately obtainable by electrochemical or optical detection in the measurement of analog data such as the presence of biomaterials, reactivity thereof, and the like. Recently, as the environmental pollution becomes more serious day by day with the rapid industrial development, the importance of the bioenvironmental industry particularly with regard to the detection of contamination by pathogenic microorganisms is increasing.

In a conventional optical method of measuring the concentration of microorganisms, the fluorescence of a specific wavelength emitted when the molecules constituting the microorganisms (ATP, NADPH, FAD, etc.) are irradiated with light of a specific wavelength is detected. And, in a conventional molecular analysis type method, the presence of DNA/RNA or proteins or the change of characteristics thereof is measured, for example, by Polymerase chain reaction (“PCR”) or Enzyme-Linked Immunosorbet Assay (“ELISA”), and the like.

And, in a conventional electrical measurement method, the change of electrical properties of electrodes due to the presence of microorganisms is measured. That is, the change of impedance is measured when the microorganisms contained in solution pass through a micro channel between electrodes. Among the conventional electrical measurement methods, the measurement method using the negative charge of microorganisms measures a voltage caused by the concentration difference of the microorganisms near the measurement electrode and the reference electrode.

### BRIEF SUMMARY OF THE INVENTION

The present invention has made an effort to solve the above-stated problems and an aspect of the present invention provides an apparatus and a method for electromagnetically detecting microorganisms.

According to an exemplary embodiment, the present invention provides an apparatus for electromagnetically detecting microorganisms which includes a pair of first electrodes which are positioned to be opposite each other on a measuring cell and are connected to a power supply which generates an electric field around a solution contained in the measuring cell, a magnetic field generating unit which generates a magnetic field around the solution contained in the measuring cell in a perpendicular direction to the electric field, second electrodes which are positioned perpendicularly to the electric field and the magnetic field, and a voltage measurer which measures a voltage generated between the second electrodes as the microorganisms move in the measuring cell. Further, according to an exemplary embodiment, the apparatus is capable of analyzing the presence, quantity and identity of the microorganisms.

### BRIEF DESCRIPTION OF THE DRAWINGS

The above and/or other aspects, features and advantages of the present invention will become more apparent from the following detailed description when taken in conjunction with the accompanying drawings, in which:

FIG. 1 illustrates an exemplary embodiment of a structure of an apparatus for electromagnetically detecting microorganisms according to the present invention;

FIG. 2 illustrates another exemplary embodiment of a structure of an apparatus for electromagnetically detecting microorganisms according to the present invention;

FIG. 3 illustrates another exemplary embodiment of an arrangement of second electrodes of an apparatus for electromagnetically detecting microorganisms according to the present invention;

FIG. 4 illustrates still another exemplary embodiment of a structure of an apparatus for electromagnetically detecting microorganisms according to the present invention;

FIG. 5 illustrates a top view of the apparatus for electromagnetically detecting microorganisms of FIG. 4; and

FIG. 6 is a flowchart illustrating an exemplary embodiment of a method for electromagnetically detecting microorganisms according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, exemplary embodiments of the present invention will be described in detail with reference to the accompanying drawings.

The Hall effect refers to a phenomenon such that when a magnetic field is applied to a direction perpendicular to a conductor in which an electric current flows, the electrons in the conductor are moved to a direction perpendicular to the electric current and the magnetic field due to Lorentz force, and thus, occurs a Hall voltage due to a difference of electron densities.

Further, electromagnetophoresis refers to the phenomenon such that when a homogeneous conducting fluid passes through a uniform electric current and a uniform magnetic field perpendicular to the current, the volume element of the fluid is moved by the Lorentz force.

According to an exemplary embodiment, the present invention provides an apparatus and a method for electromagnetically detecting microorganisms by which microorganisms with negative charge in a solution are moved by the Lorentz force resulting from an electric field and a magnetic field perpendicular to each other, and the voltage resulting from the concentration difference of the microorganisms is measured using a pair of electrodes, so as to determine the presence, quantity and identity of the microorganisms.

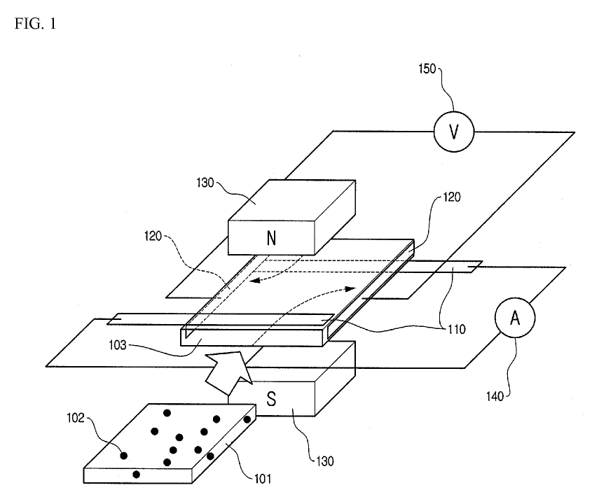

FIG. 1 illustrates an exemplary embodiment of a structure of an apparatus for electromagnetically detecting microorganisms according to the present invention.

As shown in FIG. 1, first electrodes 110 are a pair of electrodes which are positioned to be opposite to each other on a measuring cell 103. The first electrodes 110 are connected to a power supply 140 so as to generate an electric field around a solution 101 contained in the measuring cell 103. In the current exemplary embodiment, for example, the measuring cell 103 may be a storage receptacle having a rectangular parallelepiped shape which stores the solution 101 containing microorganisms 102. However, the measuring cell 103 is not limited to being any particular shape and therefore, and may vary as necessary. The measuring cell 103 includes the pair of first electrodes 110 which are provided with an electric current to generate an electric field, and a pair of second electrodes 120 for voltage measurement which are positioned perpendicular to the first electrodes 110 for electric field generation.

Since an exemplary embodiment of an apparatus for electromagnetically detecting microorganisms detects microorganisms using the measuring cell 103, it does not require a micro channel and, thus, can be manufactured easily. Further, according to an exemplary embodiment, the measuring cell 103 is used again after washing, and a large quantity of sample is analyzed depending on the size of the measuring cell 103. Accordingly, the measurement time can be reduced.

According to an exemplary embodiment, the second electrodes 120 are a pair of electrodes which are positioned to be opposite each other on the measuring cell 103, and are positioned perpendicularly to the first electrodes 110. Further, a Hall voltage is applied between the second electrodes 120 as the microorganisms 102 move.

A magnetic field generating unit 130 is positioned perpendicularly to both the first electrodes 110 and the second electrodes 120 and generates a magnetic field. In an exemplary embodiment of the present invention, the magnetic field generating unit 130 includes at least one of a solenoid electromagnet or a permanent magnet, for example.

Further, a voltage measurer 150 measures a voltage generated between the second electrodes 120 as the microorganisms 102 in the measuring cell 103 move. The microorganisms 102 in the measuring cell 103 are moved by the Lorentz force because the second electrodes 120 are positioned perpendicularly to both the electric field and the magnetic field, and contact with one of the second electrodes 120, thereby resulting in a voltage between the second electrodes 120.

According to an exemplary embodiment, the apparatus for electromagnetically detecting microorganisms does not require a membrane or other means to keep the concentration difference between the measurement electrodes and prevent the microorganisms 102 from contacting one of the electrodes. Further, there is no problem of clogging, which may occur when a micro channel or a porous membrane is used.

In order to commercialize the apparatus for electromagnetically detecting microorganisms, the apparatus needs to be small-scaled and low-powered. To this end, a permanent magnet is used to generate the magnetic field. However, when a permanent magnet is used, the resulting magnetic field is not strong enough. As a result, the movement speed of the microorganisms 102 by the Lorentz force is decreased. In order to solve this problem, the spacing of the second electrodes 120 for Hall voltage measurement may be decreased.

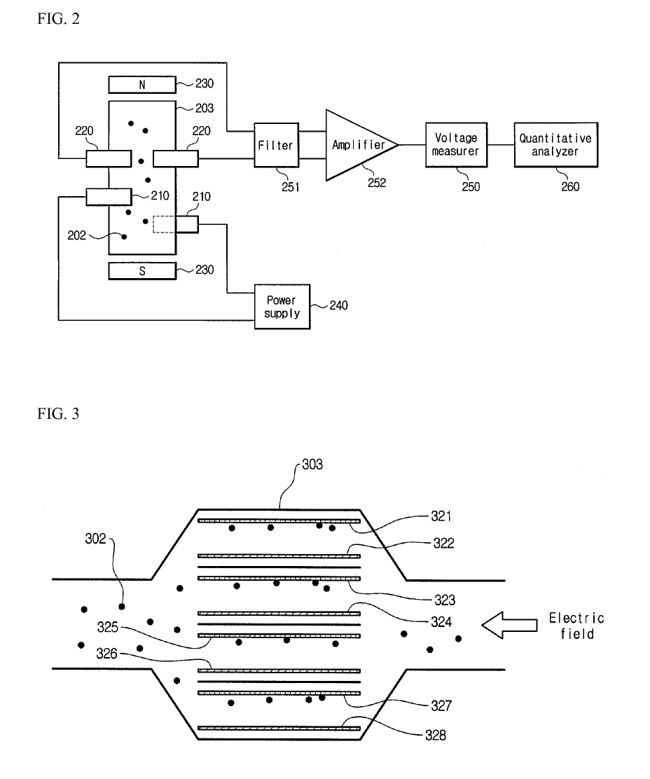

FIG. 2 illustrates another exemplary embodiment of a structure of an apparatus for electromagnetically detecting microorganisms according to the present invention.

As shown in FIG. 2, first electrodes 210 are a pair of electrodes which are positioned to be opposite each other on a measuring cell 203. The first electrodes 210 are connected to a power supply 240 so as to generate an electric field around a solution contained in the measuring cell 203.

Further, as shown in FIG. 2, second electrodes 220 are a pair of electrodes which are positioned to be opposite to each other on the measuring cell 203, and are positioned perpendicularly to the first electrodes 210.

A magnetic field generating unit 230 is positioned perpendicularly to the first electrodes 210 and the second electrodes 220 and generates a magnetic field.

A voltage measurer 250 measures a voltage generated between the second electrodes 220 as the microorganisms 202 in the measuring cell 203 move. The microorganisms 202 in the measuring cell 203 are moved by the Lorentz force because the second electrodes 220 are positioned perpendicularly to both the electric field and the magnetic field, and contact with one of the second electrodes 220, thereby resulting in a voltage between the second electrodes 220.

A filter 251 removes noise from the voltage generated between the second electrodes 220, and transfers the noise-removed voltage to the voltage measurer 250 via an amplifier 252. According to an exemplary embodiment, the filter 251 includes, for example, a low-pass filter or a high-pass filter so as to remove the noise.

The amplifier 252 amplifies the voltage generated between the second electrodes 220, and transfers amplified voltage to the voltage measurer 250. According to an exemplary embodiment, the amplifier 252 includes, for example, a differential amplifier. However, the present invention is not limited hereto, and may vary as necessary.

In another exemplary embodiment of the present invention, as shown in FIG. 2, the apparatus for electromagnetically detecting microorganisms further includes a quantitative analyzer 260. The quantitative analyzer 260 is connected to the voltage measurer 250, and determines the presence and quantity of the microorganisms 202 with negative charge depending on the magnitude of the voltage measured by the voltage measurer 250.

Accordingly, according to an exemplary embodiment, the apparatus for electromagnetically detecting microorganisms detects the quantity of the microorganisms in the air, detects the quantity of the microorganisms in the water to determine whether it is drinkable, or determines whether an air conditioner or a water purifier for lowering the concentration of the microorganisms is working properly.

FIG. 3 illustrates another exemplary embodiment of an arrangement of second electrodes of an apparatus for electromagnetically detecting microorganisms according to the present invention.

In order to improve the measurement sensitivity of the apparatus for electromagnetically detecting microorganisms, as shown in FIG. 3, a plurality of pairs of Hall voltage measurement electrodes 321-328 are provided as second electrodes, and according to an exemplary embodiment, each electrode pair 321-328 is connected in series so as to amplify the voltage.

More specifically, the second electrodes 321-328 shown in FIG. 3, are positioned so that the electrodes of each electrode pair are opposite to each other with a predetermined spacing in a measuring cell 303, and are positioned perpendicularly to electric field generated by the first electrodes. That is, the plurality of electrode pairs 321-328 are paired as 321 and 322, 323 and 324, 327 and 328, respectively. The black dots in FIG. 3 indicate the microorganisms 302. For example, as the microorganisms 302 move, the electrodes 321,323,325,327 which are located in the upper positions of each electrode pair may become negative electrodes, and the electrodes 322, 324, 326, 328 which are located in the lower positions of each electrode pair may become positive electrodes.

Here, the voltage measurer outputs the voltage obtained by summing up all the voltages generated between the second electrodes 321-328 as the microorganisms 302 move in the measuring cell as measurement voltage.

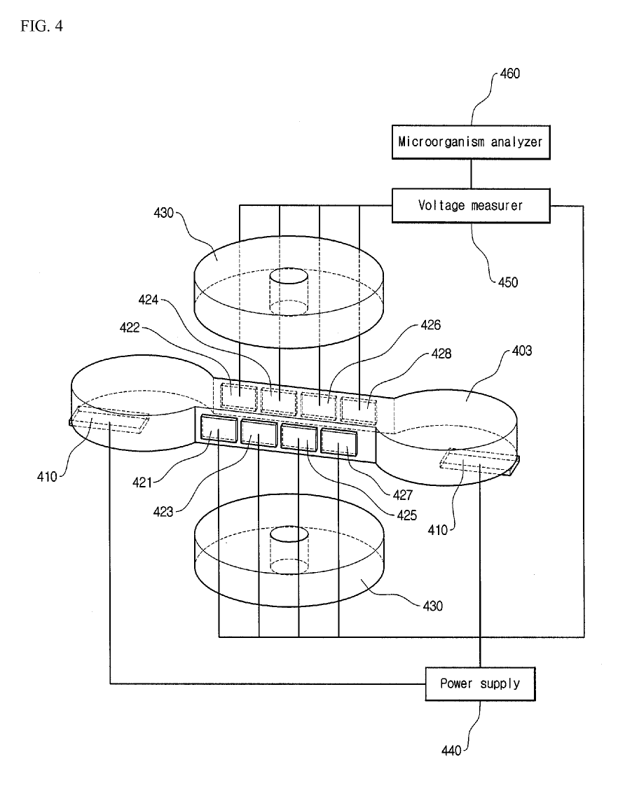

FIG. 4 illustrates a still another exemplary embodiment of a structure of an apparatus for electromagnetically detecting microorganisms according to the present invention.

As shown in FIG. 4, first electrodes 410 are a pair of electrodes which are positioned to be opposite to each other on a measuring cell 403. The first electrodes 410 are connected to a power supply 440 so as to generate an electric field around a solution contained in the measuring cell 403.

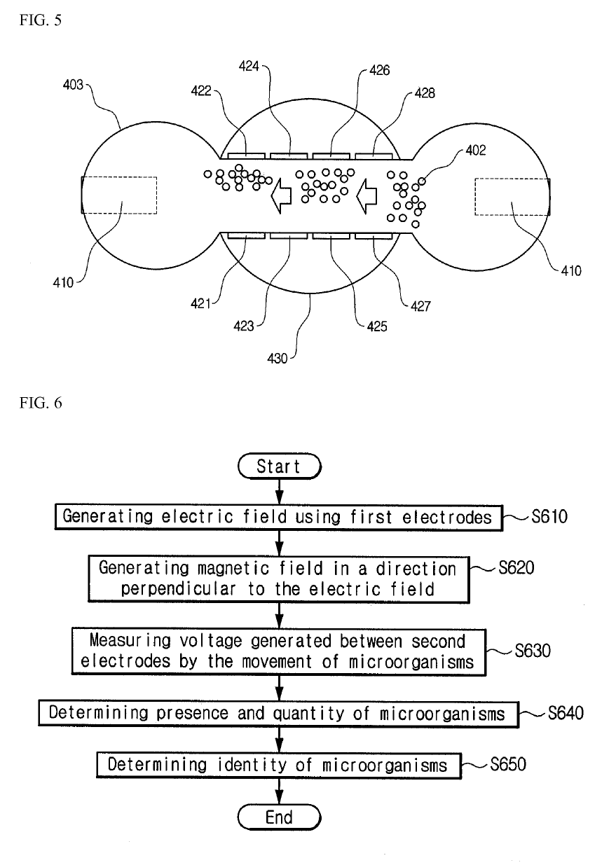

In the current exemplary embodiment, the measuring cell 403 is a dumbbell-shaped storage receptacle wherein a diameter at the portion where the measuring cell 403 is connected to the first electrodes 410 is larger than the diameter at the portion between the second electrodes 421-428. When the microorganisms 402 (see FIG. 5, for example) are moved by the electric field to one of the first electrodes 410 and are accumulated there, a new electric field may be generated by the accumulated microorganisms 402, thereby interrupting the movement of other microorganisms 402. Hence, by making the diameter at the portion where the measuring cell 403 is connected to the first electrodes 410 large, the effect of the electric field generated by the microorganisms accumulated around the first electrodes 410 can be reduced.

In the current exemplary embodiment, the apparatus for electromagnetically detecting microorganisms includes a plurality of pairs of second electrodes 421-428 for analysis of the presence, quantity and identity of the microorganisms 402. The plurality of pairs of second electrodes 421-428 are positioned with a predetermined spacing on the measuring cell 403 in a direction parallel to the electric field, with the electrodes of each electrode pair 421-428 opposite to each other.

A magnetic field generating unit 430 is positioned perpendicularly to both the first electrodes 410 and the second electrodes 420 and generates a magnetic field.

The microorganisms 402 are moved by the Lorentz force resulting from the electric field and the magnetic field when they pass through the second electrodes 421-428. Because the second electrodes 421-428 are positioned perpendicularly to the electric field and the magnetic field, voltage is generated between the second electrodes 421-428 by the movement of the microorganisms 402.

A voltage measurer 450 measures the voltage generated between the second electrodes 421-428 as the microorganisms 402 move in the measuring cell 403.

In an exemplary embodiment of the present invention, a microorganism analyzer 460 is connected to the voltage measurer 450 so as to determine the presence, quantity and identity of the microorganisms depending on the magnitude of the voltage measured by the voltage measurer 450. The process of identifying the microorganisms 402 will be described in detail referring to FIG. 5.

FIG. 5 is a top view of the apparatus for electromagnetically detecting microorganisms of FIG. 4. The microorganisms 402 contained in the measuring cell 403 are moved along one direction by the electric field generated between the first electrodes 410. As the microorganisms 402 with negative charges pass through the second electrodes 421-428, they are moved by the Lorentz force. The velocity of the microorganisms 402 is calculated by the following Equation 1:

$$V = - \frac{ɛς H {v}_{e}}{6 πη} F ( b ) \qquad Equation 1$$

where ε is the dielectric constant of the solution, ζ is the surface charge of the microorganisms 402, H is the magnitude of the magnetic field, b is the magnetic flux density, vₑ is the velocity of the microorganisms 402 by the electric field, and η is the viscosity of the solution. F(b) is computed by following Equation 2, and may have a value of 1 or 2 depending on the magnitude of the magnetic flux density b.

$$F ( b ) = 1 + b - {b}^{2} {e}^{b} Ei ( b ) , Ei ( b ) = {\int }_{0}^{∞} \frac{{e}^{- u}}{u} d u \qquad Equation 2$$

As can be seen from Equations 1 and 2, the velocity of the microorganisms 402 caused by both the electric field and the magnetic field perpendicular to each other is affected by the surface charge, velocity of the microorganisms by the electric field, etc. of the microorganisms 402. The velocity of the microorganisms 402 is further affected by the physical properties of the microorganisms 402, including volume, weight and shape.

Since different microorganisms have different surface charge and physical properties, each microorganism 402 includes a specific velocity caused by an electric field and a specific velocity caused by an electric field and a magnetic field, which are perpendicular to each other. As the microorganisms 402 pass through the second electrodes 421-428, they are moved toward either one direction of the second electrodes 421-428, and the quantity of the microorganisms 402 between the second electrodes 421-428 is decreased.

For example, given that the microorganisms 402 are moved along the direction indicated by the arrows seen in FIG. 5, the voltage generated between the second electrodes 421, 422includes a relatively smaller magnitude than the voltage generated between the electrodes 427, 428. That is, the voltage generated between the second electrodes 421, 422, the voltage generated between the second electrodes 423, 424, the voltage generated between the second electrodes 425, 426 and the voltage generated between the electrodes 427, 428 are different depending on the velocity of the microorganisms 402. According to an exemplary embodiment, the voltage difference between the second electrodes 421-428 is determined specifically be the identity of the microorganisms.

According to an exemplary embodiment, the microorganism analyzer 460 determines the identity of microorganisms 402 in the measuring cell 403 by comparing the voltages generated between the electrode pairs of the second electrodes 421-428 with microorganism-specific voltage patterns.

In an exemplary embodiment of the present invention, the spacing between the first electrodes 410 and the spacing between each electrode pair of the second electrodes 421-428 is set with a predetermined proportion.

The velocity of the microorganisms 402 caused by the electric field is relatively larger than the velocity of the microorganisms 402 caused by both the electric field and the magnetic field, which are perpendicular to each other. For example, when microorganisms 402 with a charge of approximately 20 mV are present in 10 mmol KCl solution and an electric field of 10 mA and a magnetic field of 0.3 T are generated, the proportion of the velocity of the microorganisms 402 caused by the electric field to the velocity of the microorganisms caused by both the electric field and the magnetic field, which are perpendicular to each other, is approximately 125:1.

Accordingly, by increasing the spacing between the first electrodes 410 relatively to the spacing between the electrode pairs of the second electrodes 421-428, the measurement of the microorganisms 402 can be performed effectively.

FIG. 6 is a flowchart illustrating an exemplary embodiment of a method for electromagnetically detecting microorganisms according to the present invention, while reference FIG. 1, for example.

During the measurement of the microorganisms 102, the measuring cell 103 stores the solution 101 containing the microorganisms 102. The cell is equipped with a pair of electrodes (first electrodes 110) for electric field generation and a pair of electrodes (second electrodes 120) for voltage measurement.

First, at operation 610, when the solution 101 containing the microorganisms 102 is introduced into the measuring cell 103 by a fluid control device (not shown) such as a pump, an electric current is supplied to the pair of electrodes for electric field generation 110, and an electric field is generated. The pair of electrodes 110 for electric field generation is positioned to be opposite to each other in the measuring cell 103, and is connected to the power supply 140 so as to generate an electric field around the solution 101 in the measuring cell 103.

Then, at operation 620, a magnetic field is generated around the measuring cell 103 in a direction perpendicular to the electric field by applying an electric current to a coil or using a permanent magnet. Here, the coil or the permanent magnet is positioned to generate a magnetic field in a direction perpendicular to both the pair of electrodes 110 for voltage measurement and the pair of electrodes 120 for electric field generation.

As such, the microorganisms 102 having a negative charge are moved by the electric field toward the positive electrode of the pair of first electrodes 110 for electric field generation, and are moved toward one of the pair of second electrodes 120 for voltage measurement in a direction perpendicular to the electric field and the magnetic field by the Lorentz force. As a result, the concentration of the microorganisms 102 increases near one of the pair of second electrodes 120 for voltage measurement and decrease near the other electrode.

Then, at operation 630, the voltage resulting between the measurement electrodes, which are the second electrodes 120, from the concentration difference of the microorganisms 102 having a negative charge is measured. In the current exemplary embodiment, the pair of second electrodes 120 for voltage measurement is positioned in the measuring cell 103 to be opposite each other in a direction perpendicular to the pair of electrodes for electric field generation, and is connected to an analog or digital voltage measurer 250 (shown in FIG. 2) via an electrical circuit such as a filter 251 (shown in FIG. 2) or an amplifier 252 (shown in FIG. 2).

Next, at operation 640, the presence and quantity of the microorganisms 102 are determined from the magnitude of the measured voltage. Further, at operation 650, the identity of the microorganisms is determined by using a plurality of pairs of electrodes for voltage measurement and comparing the voltages generated between the electrode pairs with microorganism-specific voltage patterns.

While the present invention has been shown and described with reference to some exemplary embodiments thereof, it should be understood by those of ordinary skill in the art that various changes in form and details may be made therein without departing from the spirit and scope of the present invention as defined by the appending claims.

What is claimed is:

1. An apparatus for electromagnetically detecting microorganisms, comprising:
a pair of first electrodes which are positioned to be opposite to each other on a measuring cell, and are connected to a power supply to generate an electric field around a solution contained in the measuring cell;
a magnetic field generating unit which generates a magnetic field around the solution contained in the measuring cell in a perpendicular direction to the electric field;
second electrodes which are positioned perpendicularly to the electric field and the magnetic field; and
a voltage measurer which measures a voltage generated between the second electrodes as the microorganisms move in the measuring cell.

2. The apparatus for electromagnetically detecting microorganisms according to claim 1, wherein the measuring cell is a storage receptacle of a rectangular parallelepiped shape which stores the solution having the microorganisms therein.

3. The apparatus for electromagnetically detecting microorganisms according to claim 1, wherein the measuring cell is a dumbbell-shaped storage receptacle which stores a solution containing microorganisms, both ends of which are connected to the pair of first electrodes and a diameter at portions where the measuring cell is connected to the pair of first electrodes is larger than a diameter at other portions.

4. The apparatus for electromagnetically detecting microorganisms according to claim 1, wherein the magnetic field generating unit comprises at least one of a solenoid electromagnet or a permanent magnet.

5. The apparatus for electromagnetically detecting microorganisms according to claim 1, wherein the pair of second electrodes comprise a pair of electrodes which are positioned to be opposite each other on the measuring cell.

6. The apparatus for electromagnetically detecting microorganisms according to claim 1, wherein the pair of second electrodes comprise a plurality of pairs of electrodes, each pair of second electrodes being positioned in series to be opposite each other in the measuring cell in a direction perpendicular to the electric field, with a predetermined spacing therebetween.

7. The apparatus for electromagnetically detecting microorganisms according to claim 1, wherein the pair of second electrodes comprise a plurality of pairs of electrodes, each pair of second electrodes being positioned to be opposite to each other on the measuring cell in a direction parallel with the electric field, with a predetermined spacing therebetween.

8. The apparatus for electromagnetically detecting microorganisms according to claim 7, wherein
the voltage measurer measures the voltage generated between the pair of second electrodes, and
which further comprises a microorganism analyzer which is connected to the voltage measurer to determine the identity of the microorganisms in the measuring cell depending on the voltage measured by the voltage measurer.

9. The apparatus for electromagnetically detecting microorganisms according to claim 1, wherein the predetermined spacing between the first electrodes and the predetermined spacing between the second electrodes are set with a predetermined proportion.

10. The apparatus for electromagnetically detecting microorganisms according to claim 9, wherein the predetermined proportion is a proportion of the velocity of the microorganisms caused by the electric field to the velocity of the microorganisms caused by the electric field and the magnetic field, which are perpendicular to each other.

11. The apparatus for electromagnetically detecting microorganisms according to claim 1, further comprising:
a filter which removes noise from the voltage generated between the second electrodes;
an amplifier positioned between the filter and the voltage measurer, which receives the noise-removed voltage and amplifies the voltage generated between the second electrodes, and transfers the amplified voltage from the filter to the voltage measurer.

12. The apparatus for electromagnetically detecting microorganisms according to claim 11, wherein the filter comprises at least one of a low-pass filter or a high-pass filter to remove the noise.

13. The apparatus for electromagnetically detecting microorganisms according to claim 1, further comprising an amplifier which amplifies the voltage generated between the second electrodes, and transfers the amplified voltage to the voltage measurer.

14. The apparatus for electromagnetically detecting microorganisms according to claim 13, wherein the amplifier comprises a differential amplifier.

15. The apparatus for electromagnetically detecting microorganisms according to claim 1, further comprising a quantitative analyzer which is connected to the voltage measurer, and determines a presence and quantity of the microorganisms having a negative charge depending on a magnitude of the voltage measured by the voltage measurer.

16. A method for electromagnetically detecting microorganisms, comprising:
generating an electric field around a solution in a measuring cell using a pair of first electrodes which are positioned to be opposite to each other on the measuring cell;
generating a magnetic field around the solution in the measuring cell in a direction perpendicular to the electric field using a magnetic field generating unit; and
measuring a voltage generated between the second electrodes as microorganisms move in the measuring cell using second electrodes, the second electrodes being positioned perpendicularly to both the electric field and the magnetic field.

17. The method for electromagnetically detecting microorganisms according to claim 16, further comprising:
determining a presence and a quantity of the microorganisms in the measuring cell by analyzing the voltage generated between the second electrodes.

18. The method for electromagnetically detecting microorganisms according to claim 16, further comprising:
determining an identity of the microorganisms in the measuring cell by analyzing the voltage generated between the second electrodes.
